(19) United States
(12) Patent Application Publication
(10) Pub. No.: US 2005/0003148 A1
(43) Pub. Date: Jan. 6, 2005

(54) Single panel glass structural panel and method of making same

(76) Inventors: Peter Robert William Myles, Highland Village, TX (US); Beth Kay Eklund Cunningham, Southlake, TX (US)

Correspondence Address: JACOBSON HOLMAN PLLC, 400 SEVENTH STREET N.W., SUITE 600, WASHINGTON, DC, 20004, US

(21) Appl. No.: 10/612,076

(22) Filed: Jul. 3, 2003

(51) Int. Cl. B32B 3/12

(52) U.S. Cl. 428/116; 156/99

(57) ABSTRACT

A window-type structural panel has a glass outer panel bonded to a core panel consisting of an aluminum honeycomb core having outer and inner skin surfaces of resin impregnated fiberglass having substantially the same coefficient of thermal expansion as the aluminum honeycomb core. Design and color effects are imparted to the glass panel by film sheets, printing on adhesive layers, physical insertion of wire, cloth or other solid materials bonded in position by heat and pressure to form a uniform rigid structure of great strength and a light weight.

### BACKGROUND OF THE INVENTION

This invention is in the field of structural building wall panels and is more specifically directed to a laminated structural planar panel having a glass outer panel for use as a building wall or panel of reduced weight and cost and increased capacity for providing various visual effects.

The use of glass panels as structural components for buildings has long been recognized as being desirable because of the limitless number of visual effects which they can provide and the low maintenance which they require. However, the known glass structural panels have suffered from the disadvantages of being both heavy and expensive as a consequence of employing a laminated structure having two relatively heavy glass panels between which a bonding adhesive is provided. Other disadvantages of the prior known glass building panels include high cost of initial fabrication and the cost of high strength attachment components necessitated by the heavy weight of such conventional panels.

Examples of prior devices that have not provided solutions to the foregoing problems are found in the following discussed prior art patents.

Lay et al. U.S. Pat. No. 5,598,674 is directed to a composite glass panel which, while lighter than the previously known structures, is limited in versatility by the requirement of mounting the glass panel on an aluminum sheet which is attached to a lightweight honeycomb core by polyvinylchloride adhesive. Visual designs are painted on the aluminum sheet so as to be visible through the glass panel. In another variation, the design is painted on the inner surface of the glass panel. Unfortunately, the polyvinylchloride adhesive tends to turn yellow when subjected to ultra-violet light so as to disfigure the panel. Moreover, when the lightweight core 115 of this patent is formed of aluminum, substantial internal stress arises due to the fact that the aluminum sheet has a much higher coefficient of thermal expansion than glass and changes in ambient temperature tend to separate the glass and aluminum to delaminate and destroy the structure.

The Lay et al. patent also proposes the use of a plastic core formed of polyvinyl or similar plastic sandwiched between two aluminum skins, to one of which aluminum skins' a glass panel is bonded by a process requiring high temperature which tends to delaminate the aluminum skins from the plastic core.

A number of building panels have employed aluminum honeycombed cores for mounting thin stone sheets or the like for use as building panel structures. For example, Bourke U.S. Pat. No. 3,723,233 discloses the use of a honeycombed aluminum sheet 1, faced on both sides with thin sheets of glass fiber 2 and 3, held in position by epoxy or polyester resin adhesive with a marble lamina 4 being laid upon one of the thin glass fiber sheets. Similarly, Bauer U.S. Pat. No. 4,973,506 discloses the use of a composite plate using a honeycomb core to which metal covers or plates are attached.

Nowara U.S. Pat. No. 5,718,096 discloses the use of honeycomb core structures in forming modular boxes.

Kourtides U.S. Pat. No. 4,598,007 discloses the use of a honeycomb core used in conjunction with fire resistant external panels for use in aircraft and spacecraft.

Battaglia U.S. Pat. No. 4,822,661 discloses the use of honeycomb members connected to stone panels as part of items of stone furniture.

Hillinger U.S. Pat. No. 4,749,601 discloses the use of honeycomb structures and associated polyvinylchloride sheets as part of devices for displaying goods or services.

Lin U.S. Pat. No. 5,766,702 discloses the use of embedded design features viewable through a transparent glass panel for use as decorative windows, doors and the like.

Marocco U.S. Pat. No. 4,640,850 discloses the mounting of a clear glass panel on a transparent plastic panel attached to a stone layer so as to provide a structure for protecting the stone from the environment. Additionally, U.S. Pat. Nos. 3,507,737; 4,094,717 and 6,090,464 also disclose various uses of internal structures for display panels and the like.

Honeycombed structures have also been used in imitation stone counter material as shown in U.S. Pat. No. 5,028,459.

Thus, it is evident that the prior art does not disclose or suggest solutions to the need for less expensive lighter weight visually attractive glass panel wall structures.

Therefore, it is the primary object of the subject invention to provide a new and improved structural panel that is lighter in weight and provides improved visual effects through the use of a single exterior transparent glass panel supported by a honeycomb backing.

A further object of the subject invention is the provision of a new and improved structural panel employing components having similar coefficience of thermal expansion so as to avoid separation of such laminated components from variations in ambient temperature.

Another object of the subject invention is the provision of a new and improved structural panel that is more resistant to earthquake damage.

### SUMMARY OF THE INVENTION

The various embodiments of the invention achieve the foregoing objects by providing a unique arrangement of components comprising a single glass panel mounted on and bonded to an outer resin impregnated fiberglass cloth skin which is referred to as “outer prepreg” hereinafter. It should be understood that the words “inner” and “outer” and the like are used to reflect positions of components when the assembled structural composite panel is vertically mounted in the wall of a building with the glass panel being the outermost panel. The outer prepreg is bonded or adhesively secured to an upper face of an aluminum honeycomb core. The honeycomb core has a coefficient of thermal expansion approximately the same as that of the resin in the outer prepreg which bonds the prepreg to the aluminum honeycomb core so as to preclude separation of these components due to ambient temperature variations. An interlayer of design-bearing sheet formed of vinyl, film, fabric, wood, wire mesh, stone such as marble, granite or limestone or other thin material is interposed between the inner surface of the glass panel and the outer prepreg on the honeycomb core with the glass panel being secured to the prepreg outer surface by a clear adhesive so that the design or pattern on the design-bearing sheet is visually displayed through the glass panel. An adhesive film or inner prepreg of identical construction to the outer prepreg is positioned on, and bonded to, the inner face surface of the honeycomb. It should be understood that the use of the inner prepreg is optional and need not be used in this or other embodiments in accordance with the final design size and strength requirements.

In a second embodiment of the invention, the design bearing interlayer sheet is not employed and the design is printed on the upper surface of an adhesive film adhered to the surface of the outer prepreg.

In another embodiment, the adhesive film is colored so as to have the effect of making the glass panel have the same color.

In a further embodiment, the glass panel is formed entirely of colored glass to effect the required design with or without an underlying design in sheet or adhesive print form.

The first step in the inventive method of assembling the preferred embodiments is to provide a rectangular honeycomb panel backing member of constant thickness formed of aluminum of the desired size. First, or inner, and second, or outer, rectangular prepregs, each consisting of a fiberglass cloth skin which has been pre-impregnated with resin, either epoxy, phenolic, polyester or equivalents are also provided. The first, or inner, prepreg is positioned on a carrier sheet supported on a work table or other horizontal surface. The aluminum honeycomb core backing member is then positioned on top of the inner prepreg. The second prepreg is then placed on the upwardly facing surface of the aluminum honeycomb core backing member so that the aluminum honeycomb core is positioned between the inner prepreg and the outer prepreg to define an uncured sandwich array. The uncured sandwich array is then positioned between upper and lower heatable platens in a platen press and subjected to heat and pressure to cure the resin in the inner and outer prepreg members to effect bonding of both the inner and outer prepregs to the honeycomb core so as to create a unitary composite laminated dual prepreg aluminum honeycomb core panel to which a variety of glass panels and design-providing elements can be attached. The temperature and the pressure employed in the heated platen press depend upon the particular materials that are impregnated in the prepregs. Alternatively, the inner prepreg can be omitted when the finished product does not require the additional strength and rigidity obtained with the dual prepreg assembly.

Following completion of the cure time, the composite dual prepreg aluminum honeycomb core panel is positioned to receive a glass sheet on the outer prepreg of the size and plan shape as the composite dual prepreg aluminum honeycomb core panel. A decorative design on a separate sheet or on the inner surface of the glass is interposed between the glass and the outer prepreg. An air-tight sealing tape is then provided around the edge of the assembled unit to act as a rubber gasket around the edges. A tube connector connected at one end to a vacuum pump is in communication with the interior of the assembly at the other end. Operation of the vacuum pump evacuates air from the interior of the assembly which results in atmospheric pressure forcing the glass toward the composite dual prepreg aluminum honeycomb core panel. The whole assembly is then positioned in an oven where it is subjected to heat to effect curing of the components to securely bond the glass panel to the composite dual prepreg aluminum honeycomb core panel to complete formation of the invented unitary structure.

Alternatively, one side of the glass panel can be painted prior to assembly of the structural components to provide a desired color when the glass panel is positioned on the outer prepreg of the honeycomb core panel.

Other variations of the structure and method use an EVA (ethylvinylacetate) film adhesive which has been provided with a design by conventional color-printing techniques. Such film adhesive is positioned over the outer prepreg to both provide the color and design and to bond the glass to the honeycomb core when cured in the oven for curing.

Yet, another approach is to use high quality plastic film, such as vinyl, cellophane or the like which is printed with a desired pattern, design, picture or other visual arrangement and is then sandwiched between two layers of film adhesive which is positioned between the glass and the outer prepreg of the honeycomb core panel assembly prior to heat treatment for curing as discussed in the preceding paragraphs.

### BRIEF DESCRIPTION OF THE DRAWINGS

FIG. 1 is a perspective view of a first structural panel embodiment of the invention employing a single glass panel overlaying an interlayer of film adhesive bonded to a composite dual prepreg aluminum honeycomb core panel;

FIG. 2 is an exploded perspective view of the constituent components of the embodiment of FIG. 1;

FIG. 3 is a side elevation view of a composite dual prepreg aluminum honeycomb core panel resting on a common sheet;

FIG. 3E is an exploded perspective view of composite dual prepreg aluminum honeycomb core panel embodiment of FIG. 3;

FIG. 4 is a side elevation of an alternative embodiment structural panel formed of composite single prepreg honeycomb core panel and a glass panel bonded thereto;

FIG. 4E is an exploded perspective view of the structural panel embodiment of FIG. 4;

FIG. 5 is a side elevation view of another structural panel embodiment employing a film adhesive between a honeycomb core panel and bonding a back painted glass panel to a composite dual prepreg aluminum honeycomb core panel;

FIG. 5E is an exploded side elevation view of the structural panel embodiment of FIG. 5;

FIG. 6 is a side elevation view of a further structural panel embodiment employing a patterned or etched glass panel bonded by a film adhesive to a composite dual prepreg aluminum honeycomb core panel;

FIG. 6E is an exploded side elevation view of the structural panel embodiment of FIG. 6;

FIG. 7 is a side elevation view of another structural panel embodiment employing a glass panel associated with a colored film adhesive sheet sandwiched between two layers of film adhesive bonded to a composite dual prepreg aluminum honeycomb core panel;

FIG. 7E is an exploded side elevation view of the structural panel embodiment of FIG. 7;

FIG. 8 is a side elevation view of a structural panel including a glass panel bonded to a composite aluminum honeycomb dual prepreg core panel by a layer of film adhesive, a layer design bearing printed film and a further layer of film adhesive;

FIG. 8E is an exploded side elevation view of the structural panel embodiment of FIG. 8;

FIG. 9 is a side elevation view of a further embodiment employing a glass panel attached by a layer of film adhesive to a design bearing or color providing interlayer sheet formed of vinyl or other film, fabric, wood, wire mesh, marble, granite, limestone or other thin stone or similar materials with a further layer of film adhesive being positioned between the interlayer and a composite dual prepreg aluminum honeycomb core panel;

FIG. 9E is an exploded perspective view of the embodiment of FIG. 9;

FIG. 10 is a bisecting sectional view illustrating the apparatus for effecting evacuation of the air between the glass panel and the composite dual prepreg aluminum honeycomb core panel for enabling bonding of the individual assembly components to form a unitary structural panel;

FIG. 11 is a sectional view illustrating an interlocking channel attachment mounting of any of the embodiments of the inventive structural panel to a building wall;

FIG. 11A is a shim including alternative variation of the assembly of FIG. 11;

FIG. 12 is a sectional view illustrating an anchor plate mounting of any of the embodiments of the inventive structural panel to a building wall;

FIG. 12A is a shim including alternative variation of the assembly of FIG. 12;

FIG. 13 is a sectional view illustrating a narrow interlocking channel mounting of any of the embodiments of the inventive structural panel to a building wall;

FIG. 13A is a shim including alternative variation of the assembly of FIG. 13;

FIG. 14 is a sectional view illustrating an aluminum Z-clip mounting of any of the embodiments of the inventive structural panel to a building wall;

FIG. 14A is a shim including alternative variation of the assembly of FIG. 14;

FIG. 15 is a sectional view illustrating an adhesive attachment mounting of any of the embodiments of the inventive structural panel to a building wall; and

FIG. 16 is a sectional view illustrating a glazed in panel mounting of any of the embodiments of the inventive structural panel to a building wall.

FIG. 17 is a sectional view illustrating a glazed-in mounting of an embodiment by a mullion and setting block arrangement.

### DETAILED DESCRIPTION OF THE PREFERRED EMBODIMENTS

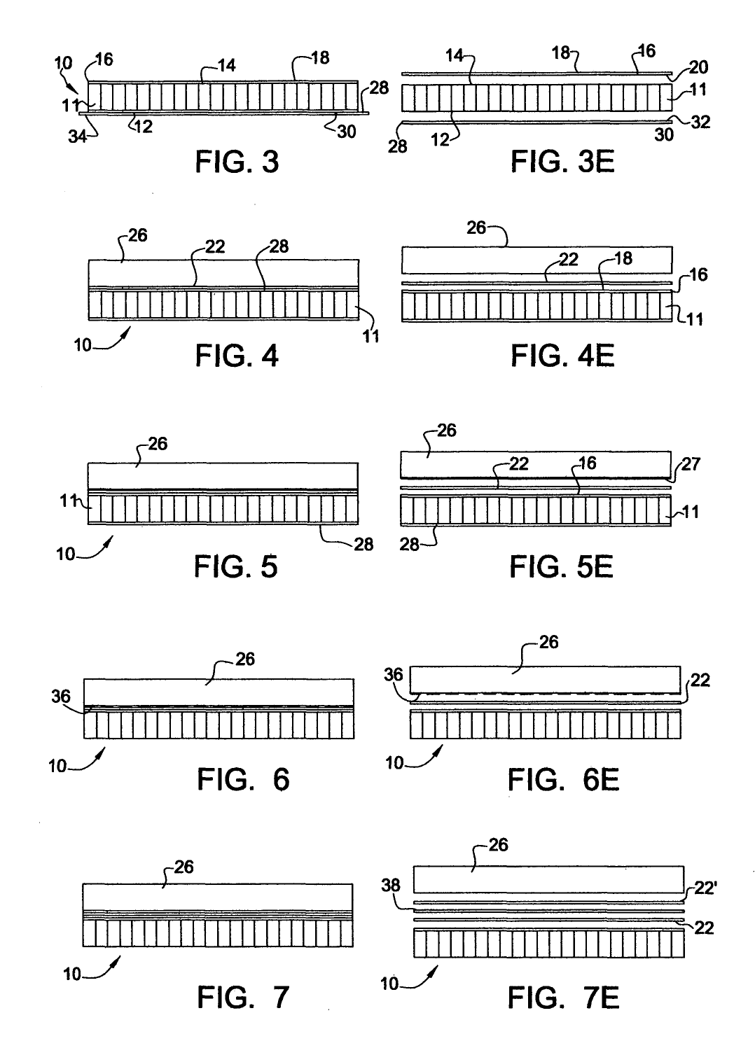

All of the embodiments of this invention employ a unique structural support member which supports an outer glass panel with design and/or color providing media. More specifically, the structural support member is a composite dual prepreg aluminum honeycomb core panel 10 which is referred to hereinafter as a “composite core” and is best illustrated in FIGS. 3 and 3E. The composite core 10 is formed of three structural elements, an aluminum honeycomb core panel 11 having an inner face surface 12 and an outer face surface 14, an outer prepreg or skin 16 bonded to outer surface 14 and an inner prepreg or skin 28 bonded to inner honeycomb surface 12.

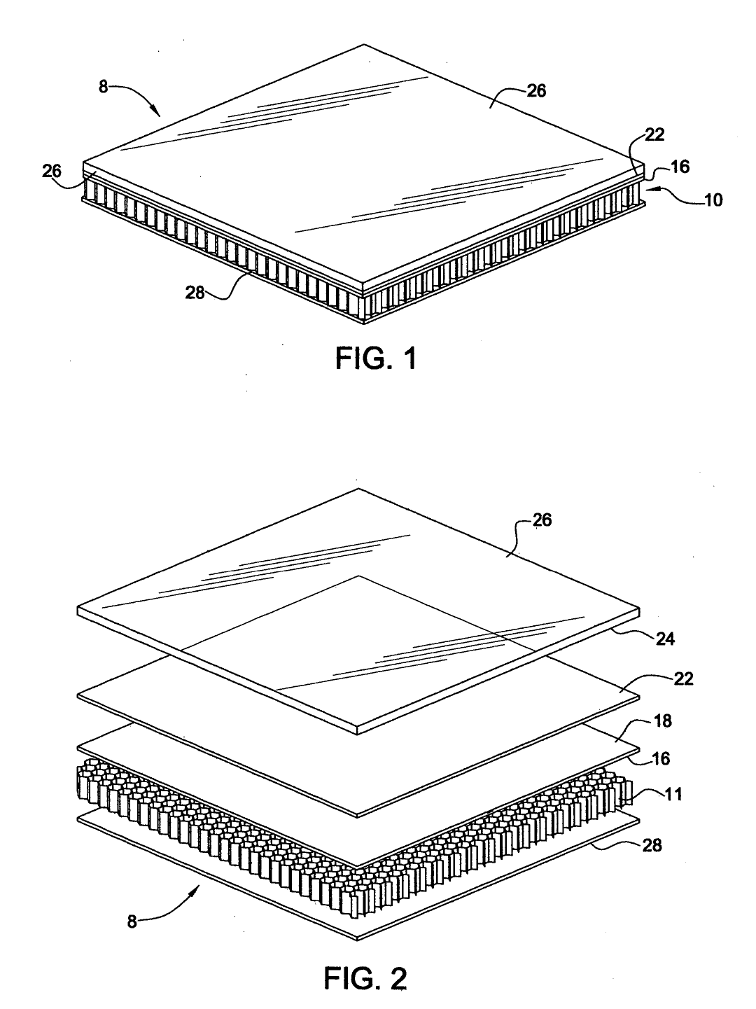

Outer prepreg 16 is formed of a resin impregnated fiberglass cloth skin having an outer skin surface 18 and an inner skin surface 20. Inner skin surface 20 is positioned on and bonded to the outer honeycomb face surface 14. Inner prepreg 28 is also formed of resin impregnated fiberglass cloth and is identical to outer prepreg 16 and has an inner skin surface 30 and an outer skin surface 32 with outer skin surface 32 being bonded to the inner honeycomb face surface 12. It should be understood that the adjectives “inner” and “outer” and equivalent language reflect the relative positioning of the components when these components are part of a structural panel which is mounted in a vertical wall of a building. However, the “inner” honeycomb face surface 12 as illustrated in FIGS. 1, 2, 3 and 3E is actually the lower surface and “outer” surface 14 is actually an upper surface as illustrated in the drawings which illustrate positions assumed by the components during the fabrication of the composite core panel 10 as reflected in FIGS. 1 through 3E.

The composite core 10 is the first item to be constructed since it is the heart of the various embodiments of the invention to which the other components are attached. The composite core 10 is formed by a process which begins with the selection of a honeycomb core 11 (FIGS. 3 and 3E) of desired size, e.g., 4 ft.×8 ft. However, it should be understood that the size of the honeycomb core can be substantially smaller, e.g., 1 ft.×1 ft. or larger, e.g., 12 ft.×6 ft. The thickness of the aluminum honeycomb core 11 will typically range from 1/16 inch to 2 inches depending upon the size and final anticipated use of the structural panel to be formed. The majority of structural panels will employ honeycomb core components ranging between 1/8 inch to 1 inch in thickness.

Following selection of the aluminum honeycomb core 11, a raw inner prepreg 28 is provided. The uncured or raw inner prepreg 28 is formed of a layer of pre-impregnated and uncured fiberglass cloth, which has been previously impregnated with either epoxy resin, phenolic resin, polyester resin or the like, and which has the same peripheral width and length dimensions as the honeycomb core and is positioned on a horizontal carrier sheet 34 (FIG. 3).

The aluminum honeycomb core 11 is then positioned on top of the inner raw prepreg 28 so that its outer face 14 faces upwardly, its bottom surface 12 rests on the carrier sheet and its side edges are in alignment with the aluminum honeycomb sides and edges. Thus, the respective side and end edges of the aluminum honeycomb core 11 and the raw inner prepreg 28 are in alignment. It should be noted that in some instances the inner prepreg 28 can be eliminated where the rigidity and structure imparted by it are not necessary for a particular installation.

An uncured raw outer prepreg or interlay skin 16 is formed of a pre-impregnated uncured fiberglass cloth impregnated with either epoxy resin, phenolic resin, polyester resin or the like and having the same shape and dimensions as the inner prepreg 28 is then provided and positioned on top of the outer honeycomb face surface 14 as shown in FIG. 3. The end and side surfaces of the outer pre preg are aligned with the end and side surfaces of the aluminum honeycomb core 10 to complete positioning of the laid up unbonded assembly of core components.

Bonding of the assembly of laid up core components is effected by placing them in the arrangement shown in FIG. 3 in a conventional heated platen press where they are subjected to heat and pressure until the resin in prepregs 16 and 28 cures to bond the prepregs to the aluminum honeycomb core 11 to result in formation of a unitary composite core 10. When epoxy and phenolic resins are used the typical pressure will be 20 to 40 psi and 300° F. to 350° F. for thirty (30) minutes curing time. When polyester resins are used, lower temperatures of approximately 200° F. are used with higher pressure ranging between 250 and 1,000 psi. Following completion of the curing time, the composite core 10 is ready for bonding to the glass panel 40 and design providing media if desired. The outer prepreg 16, glass panel 26 and the inner prepreg 28 have substantially the same coefficient of thermal expansion as the aluminum honeycomb core 10 so that ambient temperature variations do not result in separation of the prepreg from the aluminum honeycomb core 10 or the glass panel 26.

The first embodiment of the invention as illustrated in FIGS. 1 and 2 is formed by providing a composite core panel 10 formed in the previously described manner. An adhesive film layer 22 that has been previously provided with decorative material by printing or other conventional procedures is positioned on the upper surface 18 of outer prepreg 16. The outer prepreg planar glass panel 26 is cut to the same size as the composite core panel and is washed and dried to insure that it is perfectly clean. The glass panel thickness will be in the range of 2 mm to 20 mm with the actual thickness depending upon a variety of variables such as size of the glass panel and environment in which the structural panel of which the glass is a part is to be installed. The glass panel is then positioned on the upper surface of adhesive film 22 with its sides aligned with the sides of adhesive film 22. The resultant structure is then ready for the final bonding process.

The adhesive film 22 can be either ethylvinylacetate (EVA), polyvinylbutyl (PVB), polycarbonate (PC) or other similar adhesives, all collectively referred to hereinafter as “film adhesive”. For a standard panel provided with basic colors or a simple or low definition design, the EVA film adhesive may be colored using a commercial ink jet type printer or other standard color printing techniques. In these circumstances, the adhesive film is both to provide color and to bond the glass to the composite core panel 10.

An alternative embodiment can be provided by painting the inner side of the glass panel that is to be secured by the adhesive film. Such embodiment consequently does not have a visible design; however, it results in the provision of a glass panel which appears to be colored so as to provide a decorative effect.

The final step in effecting fabrication of the structural panel stack is to effect bonding of the glass panel 26 to composite core 10. FIG. 10 illustrates a portion of the equipment employed for effecting bonding the adhesive film 22 and the glass panel 26 to the composite core 10. More specifically, a circular synthetic rubber gasket 50 is positioned to extend around the entire outer periphery of the stacked assembly 10, 22, 26, etc. and is held in position by air tight sealing tape 52. A tube connector is attached to the rubber gasket at a single point on the perimeter of the gasket to provide communication of the space inwardly of the synthetic rubber gasket 50. A hose 56 is connected on one end to the tubular connector 54 and on an opposite end to a vacuum pump which is not shown in the drawings. Operation of the vacuum pump effects removal of a substantial portion of the air so as to create a vacuum between the glass panel 26 and the composite core 10 so that ambient atmospheric pressure presses the glass and the composite panel together with substantial force. The vacuum is maintained while the whole assembly is placed in an oven where it is subjected to heat for effecting the curing of the adhesive components to bond the glass panel 26 to the composite core 10. The temperature range is normally 90° C. to 150° C. (160° F. to 270° F.) for a period of about two (2) hours.

Following completion of the aforementioned heating cycle, the fully cured panel is removed from the oven and the gasket, tape and vacuum pipe are disconnected. The finished structural panel is either packaged for shipping or sent for further fabrication such as being cut into smaller panel sizes or cut into different shapes or for providing mounting hardware for effecting connection of the structural panel to a building wall or the like.

It should be noted that the final assembly will be attached to a building structure by suitable connectors, the design of which will depend upon the particular building structure and environment.

FIGS. 5 and 5E illustrate a second embodiment in which the glass panel 26 is provided with a coating of paint 27 which makes the panel 26 have the same color as the paint coating. The final bonding of the components of this embodiment is provided as discussed above and by use of the equipment of FIG. 10 and an oven.

FIGS. 6 and 6E illustrate a third embodiment in which the glass panel 26 is provided with a patterned or etched glass design 36 on its inner face. The final assembly of this embodiment is effected in the same manner as that of the embodiment of FIGS. 1 and 2 by use of an oven and the equipment illustrated in FIG. 10.

FIGS. 7 and 7E illustrate a fourth embodiment employed for providing high definition or high quality colors which are printed on a sheet of plastic film such as vinyl, cellophane or the like with the printed material being in a desired pattern, design, picture or two dimensional imprint that could be computer generated, scanned or drawn and transferred to a printing device or even hand painted. The film 38 is sandwiched between the adhesive film 22 and a second adhesive film 22′ as best shown in FIG. 7E following which curing is effected by use of the FIG. 10 equipment and an oven.

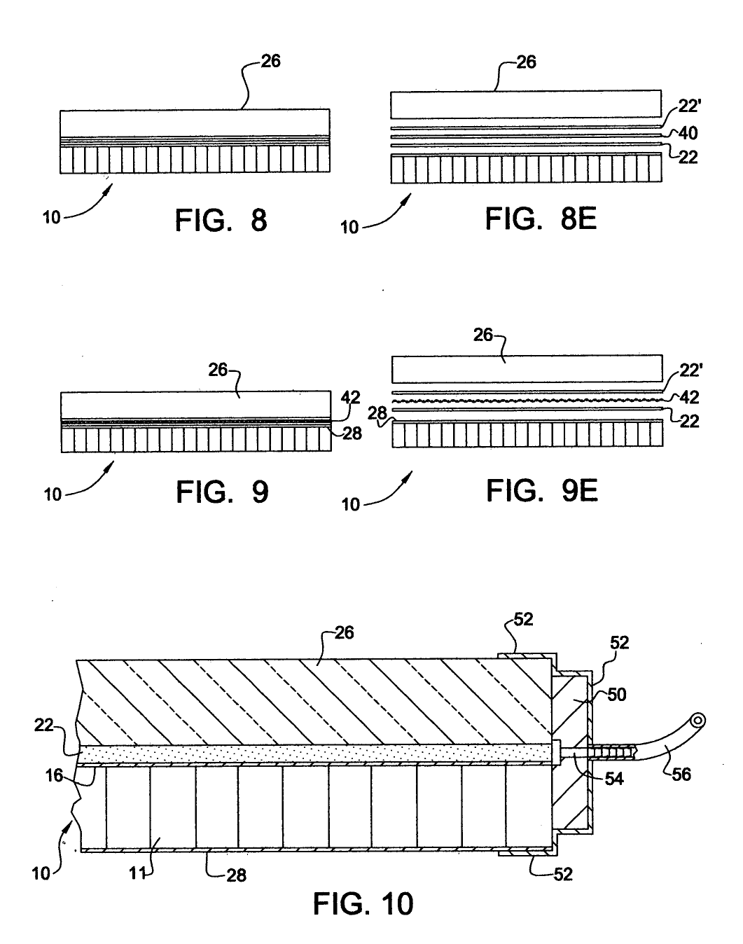

FIGS. 8 and 8E illustrate a fifth embodiment which is similar to the embodiment of FIGS. 7 and 7E with the exception of the fact that the design is in the form of a woven cloth, straw or the like mat 40 which is positioned between film adhesive layers 22 and 22′. The embodiment of FIGS. 8 and 8E is finally assembled in the manner of the embodiment of FIGS. 1 and 2 by use of the equipment shown in FIG. 10 and an oven.

FIGS. 9 and 9E illustrate a sixth embodiment which is similar to the embodiments of FIGS. 7 and 8, but in which the design is a design bearing or color providing interlayer 42 formed of vinyl or other film, fabric, wood, wire mesh, marble, granite, limestone or other thin stone panels or similar materials positioned between adhesive film layers 22 and 22′. Assembly is effected in the manner of the previously discussed embodiments using the FIG. 10 equipment and an oven.

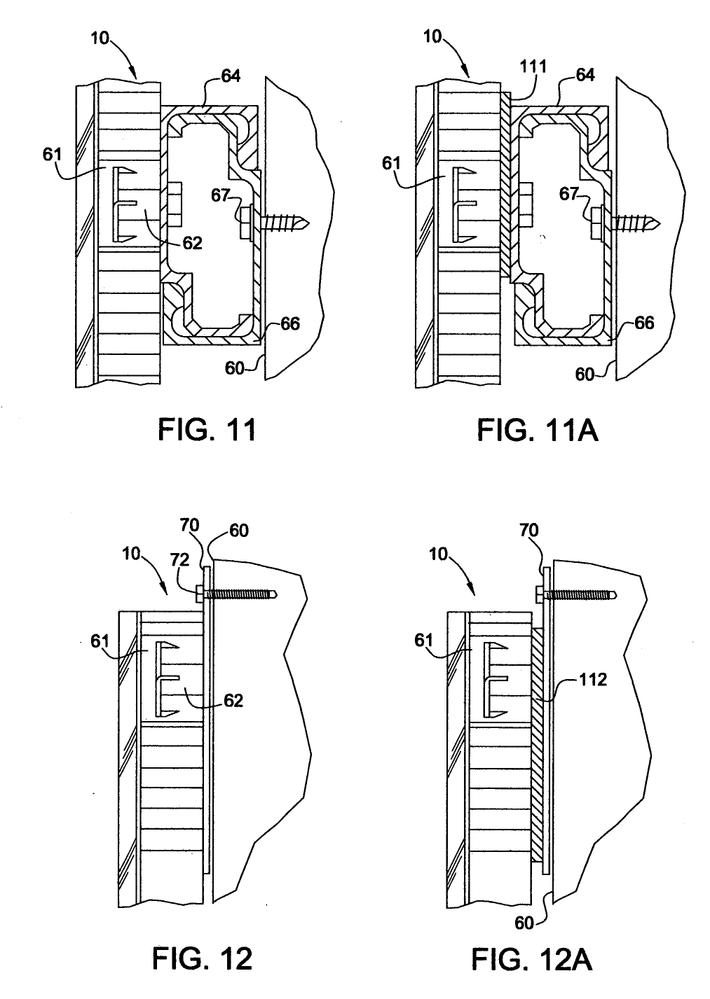

FIGS. 11 through 16 illustrate a variety of options for attaching any of the composite core panels 10 on back-up framing 60 of the building. The composite core panels 10 of FIGS. 11, 12, 13 and 14 are all provided with an epoxy-fill through space 61, in which an anchor 62 is positioned in the epoxy to provide a strong connection between the building and the composite core panel 10.

An interlocking aluminum extrusion channel 64 is attached to the anchor 62 in the factory in the embodiment shown in FIG. 11. A field attached interlocking aluminum extrusion channel mating section 66 is attached by screw 67 to the back-up framing 60 to receive the aluminum extrusion channel 64 so as to provide support for the composite core panel as shown in FIG. 11.

The narrow interlocking channel mounting assembly of FIG. 11A is similar to that of FIG. 11; however, this embodiment employs a factory attached aluminum extrusion interlocking channel 164 of less width than the interlocking channel 64 of FIG. 11. Also, a field attached aluminum extrusion interlocking channel 166 attached to back-up framing 60 is of reduced width as compared to field attached interlocking channel 66 of FIG. 11.

The anchor plate embodiment of FIG. 12 employs a factory attached steel anchor plate 70 fixedly attached to anchor 62 and attached to back-up framing 60 by screws 72 extending through a hole in the anchor plate.

FIG. 12A illustrates an alternative variation of the assembly of FIG. 12 which additionally includes a shim 112.

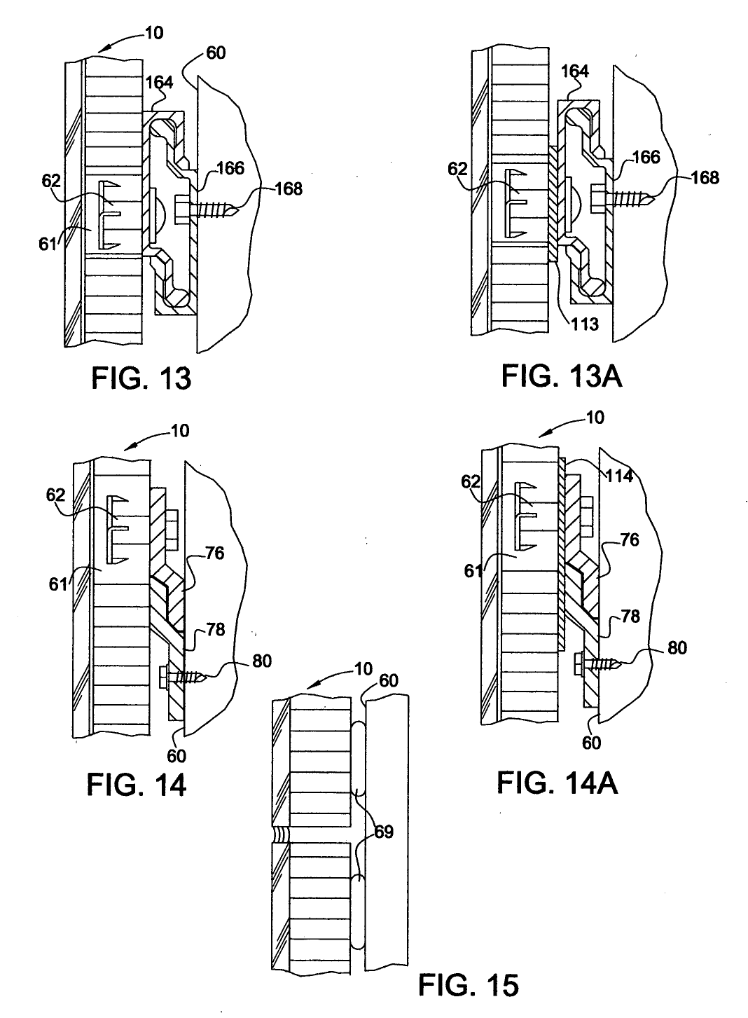

FIG. 13 illustrates a narrow interlocking aluminum extrusion channel assembly comprising a field attached aluminum extrusion support 166 attached by screw 168 to back-up framing 60 which supports a factory attached aluminum extrusion interlocking channel 164.

FIG. 13A illustrates an alternative variation of the assembly of FIG. 13 which additionally includes a shim 113.

An aluminum extrusion Z-section 76 is attached in the factory to the anchor 62 by a T-rivet as shown in FIG. 14. A field attached Z-plate 78 is attached to the back-up framing 60 by screws 80 and supportingly engages the composite core panel 10 and Z-section 76 to provide support for the core panel in an obvious manner as shown in FIG. 14.

FIG. 14A illustrates an alternative variation of the assembly of FIG. 14 which additionally includes a shim 114.

FIG. 15 illustrates attachment of a composite core panel 10 to back-up framing 60 by panel adhesive 69.

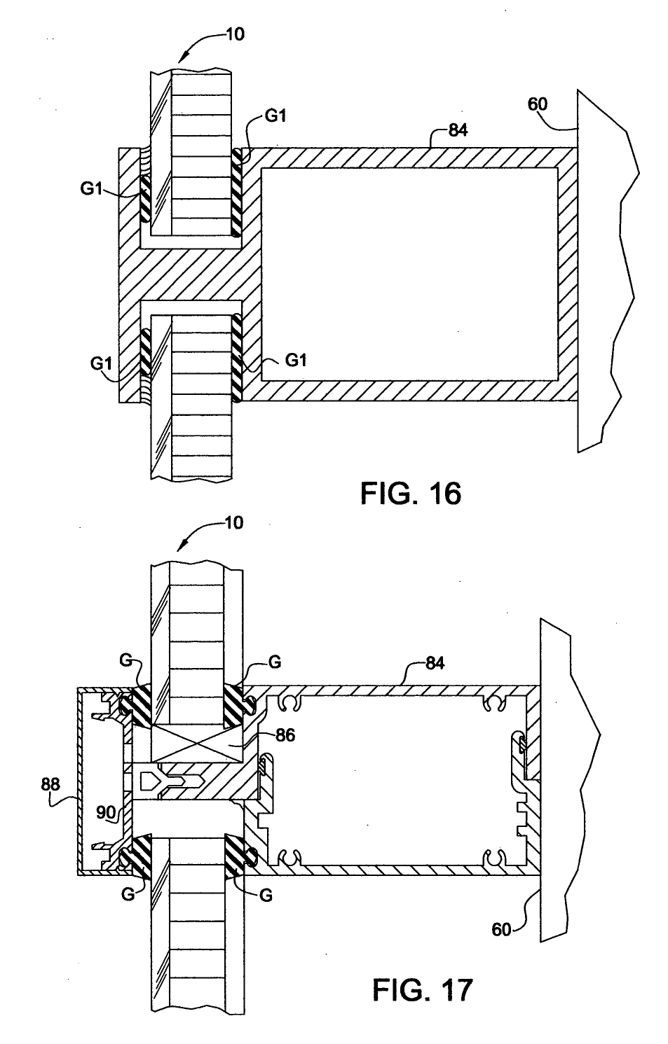

FIG. 16 illustrates typical glazed-in panel 10 supported by an aluminum extrusion mullion 80 attached to back-up framing 60 with gaskets G1 holding the panel in position.

FIG. 17 illustrates further a glazed-in panel 10 supported by aluminum extrusion mullion 84. A setting block 86 is positioned between mullion 84 and the composite core panel 10 with an outer housing 88 enclosing an aluminum extrusion retainer 90. Gaskets G1 engage the inner and outer portions of the core 10 so as to prevent transverse movement thereof.

It should be understood that the film and adhesive layers as illustrated in the drawings have an exaggerated thickness for the purpose of clarity, but are in actuality much thinner compared to the other components than as shown in the drawings.

It should also be understood that the invention is not limited to the precise embodiments described and the spirit and scope of the invention is to be determined solely by the attached claims.

1. A composite structural panel comprising a planar glass panel having an inner surface and an outer surface, a honeycomb core panel having an outer honeycomb face surface and an inner honeycomb face surface, an outer prepreg including a non-metal interlay skin which has an inner skin surface and an outer skin surface, the inner skin surface of the outer non-metal interlay skin being adhesively secured to the outer honeycomb face surface of the honeycomb core panel and the outer skin surface of the outer non-metal interlay skin being adhesively secured to the inner surface of the planar glass panel by an adhesive interlayer to securely retain the glass panel to the honeycomb core panel and wherein a desired visual effect such as color and/or design is provided to the adhesive interlayer so as to be visible through the glass panel.

2. A composite panel as recited in claim 1, wherein the outer non-metal interlay skin is formed of resin impregnated fiberglass cloth.

3. A composite panel as recited in claim 2, additionally including an inner non-metal interlay skin bonded to the inner honeycomb face surface of the honeycomb core panel.

4. A composite structural panel as recited in claim 3, wherein the inner non-metal interlay skin is formed of resin impregnated fiberglass cloth.

5. A composite structural panel as recited in claim 1, wherein the visual effect is provided by printing on the adhesive interlayer.

6. A composite structural panel as recited in claim 1, wherein the visual effect is provided by an image providing sheet bearing a visible design and positioned between, and adhesively secured to, the outer skin surface of the outer non-metal interlay skin and the inner surface of the planar glass panel.

7. A composite structural panel as recited in claim 1, wherein the visual effect is provided by an image providing vinyl sheet bearing a design and positioned between, and adhesively secured to, the outer skin surface of the outer non-metal interlay skin and the inner surface of the planar glass panel.

8. A composite structural panel as recited in claim 1, wherein the outer non-metal interlay skin is formed of resin impregnated fiberglass cloth and the visual effect is provided by an image providing sheet bearing a visible design and positioned between, and adhesively secured to, the outer skin surface of the outer non-metal interlay skin and the inner surface of the planar glass panel.

9. A composite structural panel as recited in claim 1, additionally including an inner non-metal interlay skin adhesively secured to the inner honeycomb face surface, wherein the inner non-metal interlay skin is formed of resin impregnated fiberglass cloth and the desired visual effect is provided by an image providing sheet bearing a visible design and positioned between, and adhesively secured to, the outer skin surface of the outer non-metal interlay skin and the inner surface of the planar glass panel.

10. A composite structural panel as recited in claim 1, wherein the desired visual effect is provided by an image providing fabric sheet bearing a visible design and positioned between, and adhesively secured to, the outer skin surface of the outer non-metal interlay skin and the inner surface of the planar glass panel.

11. A composite structural panel as recited in claim 1, wherein the adhesive interlayer is ethylvinylacetate.

12. A composite panel as recited in claim 11, wherein the outer non-metal interlay skin is formed of resin impregnated fiberglass cloth.

13. A composite structural panel as recited in claim 11, wherein the desired visual effect is provided by printing on the adhesive interlayer.

14. A composite structural panel as recited in claim 11, wherein the desired visual effect is provided by an image providing sheet bearing a visible design and positioned between, and adhesively secured to, the outer skin surface of the outer non-metal interlay skin and the inner surface of the planar glass panel.

15. A composite structural panel as recited in claim 11, wherein the desired visual effect is provided by an image providing vinyl sheet bearing a visible design and positioned between, and adhesively secured to, the outer skin surface of the outer non-metal interlay skin and the inner surface of the planar glass panel.

16. A composite structural panel as recited in claim 1, wherein the adhesive interlayer is polyvinylbutyl.

17. A composite panel as recited in claim 16, wherein the outer non-metal interlay skin is formed of resin impregnated fiberglass cloth.

18. A composite structural panel as recited in claim 16, wherein the desired visual effect is provided by printing on the adhesive interlayer.

19. A composite structural panel as recited in claim 16, wherein the desired visual effect is provided by an image providing sheet bearing a visible design and positioned between, and adhesively secured to, the outer skin surface of the outer non-metal interlay skin and the inner surface of the glass panel by adhesive.

20. A composite structural panel as recited in claim 16, wherein the desired visual effect is provided by an image providing vinyl sheet bearing a visible design and positioned between, and adhesively secured to, the outer skin surface of the outer non-metal interlay skin and the inner surface of the planar glass panel.

21. A composite structural panel as recited in claim 1, wherein the adhesive interlayer is polycarbonate.

22. A composite structured panel as recited in claim 1, wherein the adhesive interlayer is colored so as to be visible through the glass panel.

23. A composite structure as recited in claim 1, wherein the honeycomb core is primarily formed of aluminum.

24. A composite panel as recited in claim 23, wherein the outer non-metal interlay skin is formed of resin impregnated fiberglass cloth.

25. A composite panel as recited in claim 24, additionally including an inner non-metal interlay skin adhesively secured to the inner honeycomb face surface of the honeycomb core panel.

26. A composite structural panel as recited in claim 25, wherein the inner non-metal interlay skin is formed of resin impregnated fiberglass cloth.

27. A composite structural panel as recited in claim 23, wherein the desired visual effect is provided by printing on the adhesive interlayer.

28. A composite structural panel as recited in claim 23, wherein the desired visual effect is provided by an image providing sheet bearing a visible design and positioned between, and adhesively secured to, the outer skin surface of the outer non-metal interlay skin and the inner surface of the planar glass panel by adhesive.

29. A composite structural panel as recited in claim 23, wherein the desired visual effect is provided by an image providing vinyl sheet bearing a design and positioned between, and adhesively secured to, the outer skin surface of the outer non-metal interlay skin and the inner surface of the planar glass panel.

30. A composite structural panel comprising a planar glass panel having an inner surface and an outer surface, a honeycomb core panel having an outer honeycomb face surface and an inner honeycomb face surface, an interlayer formed of stone which has an inner surface and an outer surface, the inner surface of the interlayer being adhesively secured to the outer honeycomb face surface of the honeycomb core panel and the outer surface of the interlayer being adhesively secured to the inner surface of the planar glass panel by an adhesive film layer to securely retain the glass panel to the honeycomb core panel and wherein a desired visual effect is provided by the interlayer so as to be visible through the glass panel.

31. A composite structural panel as recited in claim 30, wherein the interlayer is formed of marble.

32. A composite structural panel as recited in claim 30, wherein the interlayer is formed of granite.

33. A composite structural panel as recited in claim 30, wherein the interlayer is formed of limestone.

34. A composite structural panel comprising a planar glass panel having an inner surface and an outer surface, a honeycomb core panel having an outer honeycomb face surface and an inner honeycomb face surface, an interlayer formed of wire mesh which has an inner surface and an outer surface, the inner surface of the interlayer being adhesively secured to the outer honeycomb face surface of the honeycomb core panel and the outer surface of the interlayer being adhesively secured to the inner surface of the planar glass panel by an adhesive film layer to securely retain the glass panel to the honeycomb core panel and wherein a desired visual effect is provided by the interlayer so as to be visible through the glass panel.

35. A composite structural panel comprising a planar glass panel having an inner surface and an outer surface, a honeycomb core panel having an outer honeycomb face surface and an inner honeycomb face surface, an interlayer formed of fabric which has an inner surface and an outer surface, the inner surface of the interlayer being adhesively secured to the outer honeycomb face surface of the honeycomb core panel and the outer surface of the interlayer being adhesively secured to the inner surface of the planar glass panel by an adhesive film layer to securely retain the glass panel to the honeycomb core panel and wherein a desired visual effect is provided by the interlayer so as to be visible through the glass panel.

36. A composite structural panel comprising a planar glass panel having an inner surface and an outer surface, a honeycomb core panel having an outer honeycomb face surface and an inner honeycomb face surface, an interlayer formed of wood which has an inner surface and an outer surface, the inner surface of the interlayer being adhesively secured to the outer honeycomb face surface of the honeycomb core panel and the outer surface of the interlayer being adhesively secured to the inner surface of the planar glass panel by an adhesive film layer to securely retain the glass panel to the honeycomb core panel and wherein a desired visual effect is provided by the interlayer so as to be visible through the glass panel.

37. A composite structural panel comprising a planar glass panel having an inner surface and an outer surface, a honeycomb core panel having an outer honeycomb face surface and an inner honeycomb face surface, an interlayer formed of vinyl which has an inner surface and an outer surface, the inner surface of the interlayer being adhesively secured to the outer honeycomb face surface of the honeycomb core panel and the outer surface of the interlayer being adhesively secured to the inner surface of the planar glass panel by an adhesive film layer to securely retain the glass panel to the honeycomb core panel and wherein a desired visual effect is provided by the interlayer so as to be visible through the glass panel.

38. A composite structural panel comprising a planar glass panel having an inner surface and an outer surface, a honeycomb core panel having an outer honeycomb face surface and an inner honeycomb face surface, an interlayer formed of film which has an inner surface and an outer surface, the inner surface of the interlayer being adhesively secured to the outer honeycomb face surface of the honeycomb core panel and the outer surface of the interlayer being adhesively secured to the inner surface of the planar glass panel by an adhesive film layer to securely retain the glass panel to the honeycomb core panel and wherein a desired visual effect is provided by the interlayer so as to be visible through the glass panel.

39. A method of providing a composite structure incorporating a glass panel, the method comprising the steps as follows:
a. providing a metal honeycomb core panel having a planar outer core face surface and a planar inner core face surface;
b. providing a glass panel;
c. providing a resin impregnated fiberglass cloth skin sheet having first and second planar surfaces;
d. positioning the first planar surface of the resin impregnated fiberglass cloth skin in facing contact with the planar outer core face surface of the metal honeycomb core panel;
e. applying force and heat to the metal honeycomb core panel and the resin impregnated fiberglass cloth skin to urge them together and cure the resin impregnated fiberglass cloth skin and bond the fiberglass cloth skin to the metal honeycomb to provide a unitary structure;
f. positioning a layer of film adhesive in facing contact with the fiberglass cloth skin portion of the unitary structure;
g. positioning a glass panel in facing contact with the layer of film adhesive; and
h. applying force and heat to the unitary structure and the glass panel to urge them toward each other and effect a bonding of the glass panel to the unitary structure to create a finished composite structural panel.

40. The method of claim 39, wherein the layer of film adhesive is ethylvinylacetate.

41. The method of claim 39, wherein the layer of film adhesive is polyvinylbutyl.

42. The method of claim 39, wherein the layer of film adhesive is polycarbonate.

43. The method of claim 40, wherein the ethylvinylacetate film adhesive has been previously printed so as to provide a visual effect visible through the glass panel of the finished composite structure.

44. The method of claim 39, wherein force applied to the unitary structure is effected by evacuating air from within the unitary structure so that atmospheric pressure acts on the glass panel to urge the glass panel toward the metal honeycomb core.

45. A method of providing a composite structure incorporating a glass panel, the method comprising the steps as follows:
a. providing a metal honeycomb core panel having a planar outer core face surface and a planar inner core face surface;
b. providing a glass panel;
c. providing a resin impregnated fiberglass cloth skin sheet having first and second planar surfaces;
d. positioning the first planar surface of the resin impregnated fiberglass cloth skin in facing contact with the planar outer core face surface of the metal honeycomb core panel;
e. applying force and heat to the metal honeycomb core panel and the resin impregnated fiberglass cloth skin to urge them together and cure the resin impregnated fiberglass cloth skin and bond the fiberglass cloth skin to the metal honeycomb panel to provide a unitary structure;
f. positioning a layer of film adhesive in facing contact with the fiberglass cloth skin portion of the unitary structure;
g. positioning a sheet of previously printed image providing film providing a desired visual effect in facing contact with the layer of film adhesive and a second layer;
h. positioning a second layer of film adhesive in facing contact with the image providing film;
I. positioning a glass panel in facing contact with the image providing film; and
j. applying force and heat to the unitary structure and the glass panel to urge them toward each other and effect a bonding of the glass panel to the unitary structure to create a finished complete structure.
